(19) United States
(12) Patent Application Publication
(10) Pub. No.: US 2006/0169090 A1
(43) Pub. Date: Aug. 3, 2006

(54) Angled flexible extension shaft

(75) Inventors: Burton Kozak, Chicago, IL (US); Ira M. Kozak, Chicago, IL (US)

Correspondence Address: CHERSKOV & FLAYNIK, THE CIVIC OPERA BUILDING, 20 NORTH WACKER DRIVE, SUITE 1447, CHICAGO, IL, 60606, US

(73) Assignee: Burton Kozak

(21) Appl. No.: 11/328,371

(22) Filed: Jan. 9, 2006

Related U.S. Application Data
(60) Provisional application No. 60/642,002, filed on Jan. 7, 2005.

(51) Int. Cl. F16C 1/10

(52) U.S. Cl. 74/500.5

(57) ABSTRACT

A device that can impart rotational and linear force to a tool along 360 degrees range of motion, is provided, the device comprising a flexible extension shaft having a first end and a second end, whereby the first end is adapted to be received by a rotating chuck, the second end which rotates in a first plane of rotation, and an angled driver, coupled to the second end, whereby the angled driver confers rotation to the tool along a second plane of rotation.

### CLAIM FOR PRIORITY

The present application is related to, and claims priority from, U.S. Provisional Application Ser. No. 60/642,002 filed Jan. 7, 2005, the complete subject matter of which is incorporated herein by reference.

### BACKGROUND OF THE INVENTION

1. Field of the Invention

The present invention relates to the field of tools or devices that drive inter-changeable bits, and more specifically, the present invention relates to devices that impart simultaneous rotational motion to a driving bit along more than one rotational axis.

2. Background of the Invention

Flexible extension shafts are used in providing rotational force or movement to bits and to drive fasteners, and are used in hand-tool applications as are well known in the art. Known long flexible extension shafts can bend from 0 degrees to typically 45-90 degrees from their longitudinal axis. If long enough, the shaft can bend to 180 degrees. However, such long extension shafts are somewhat unwieldy, particularly in tight quarters. In close situations where an extension shaft is needed, and particularly at sharp angles (i.e., at greater than 90 degrees), neither a long extension shaft nor a typical extension shaft will work.

U.S. Pat. No. 4,876,929, awarded to the instant inventors, and owned by the instant Assignee (the '929 patent) incorporated herein by reference in its entirety, discloses a flexible rotation shaft that imparts rotary torque to a bit. The device disclosed in the '929 patent provides rotational torque over a wide range of bending angles of the shaft, such that the shaft axis bends as much as 90 degrees without degradation in rotational force. State of the art devices provide one axis of rotation, but generally do not allow for bit/fastener rotation at sharp angles.

A need exists for a device that provides the extension capabilities of state of the art extension shafts, but having greater acute angle capabilities. The device should be operable in confining spaces. Furthermore, the device should be able to impart rotational torque at greater than 90 degrees (up to approximately 180 degrees) relative to the oppositely extending end of the device.

Further limitations and disadvantages of conventional and traditional approaches will become apparent to one of skill in the art, through comparison of such systems with the present invention as set forth in the remainder of the present application with reference to the drawings.

### SUMMARY OF INVENTION

It is an object of the present invention to provide a device for providing rotational torque over a wide range of angles that overcomes many of the disadvantages of the prior art.

Another object of the present invention is to provide a device that imparts rotational torque simultaneously along more than one axis of rotation. A feature of the device is a flexible driver with a first end extending in a first direction and adapted to be received by a chuck, a second end and an angled driver attached to the second end and adapted to receive a tool. An advantage of the device is that it can simultaneously torque in a plurality of rotational axes (where the axis are not co-planar) while imposing linear force directed in the first direction.

Still another object of the present invention is to provide a device to impart rotational torque to a bit or a fastener at an acute angle relative to the source of torque power. A feature of the device is that it provides rotational force for a bit, fastener or tool, where the device itself is adapted to bend from 0 to approximately 360 degrees (but generally greater than 90 degrees up to approximately 180 degrees) in any direction relative to a chord line formed by the first and second ends of a flexible extension shaft. The first end of the shaft is positioned proximate the source of such rotational force or torque, and the second end is positioned proximate the bit, fastener or tool. An advantage of the device is that intricate manipulations of workpieces are facilitated in small or tight areas.

Briefly, the invention provides a device which imparts rotational movement and linear force to a tool, the device comprising a flexible extension shaft having first and second ends, whereby said first end is adapted to provide rotational movement in a first plane of rotation and liner force to at least said second end; and at least one angled driver coupled to said second end, whereby rotational and liner force is provided to the tool along a 360 degree range of motion.

In at least one embodiment, the flexible extension shaft can bend from 0 degrees to approximately 360 degrees from its longitudinal axis. Embodiments are contemplated in which one or more angled drivers are used in conjunction with the flexible extension shaft. Further, one or more of such angled drivers are formed having a fixed or variable (i.e., adjustable) predetermined angle greater than 0 degrees but less than 180 degrees (generally between approximately 0 and 90 degrees). The angle driver provides an axis of rotation to the tool in a plane different from the plane of axis of rotation conferred by the second end. The angled driver may be integrally molded with or removably coupled to the second end of the shaft.

The base of the angle driver may be in rotatable communication with the second end of the shaft so as to be coaxial with the axis of rotation of the shaft.

Yet another embodiment relates to imparting rotational and linear force to a tool using the device. In this embodiment, a work angle is determined as necessary to circumvent or navigate around objects or surfaces of a piece of equipment so as to arrive at a trouble region. The method comprises bending a flexible extension shaft (greater than 90 degrees for example) having first and second ends, where the second end has one or more angled drivers. A drive device is used to provide rotational and linear force to at least the first end, wherein the first end is adapted to provide rotational and linear force to at least the second end along a 360-degree range of motion as described previously. A bit is inserted into the one or more angled drivers, and rotational torque is provided thereto.

### BRIEF DESCRIPTION OF DRAWINGS

The foregoing invention and its advantages may be readily appreciated from the following detailed description of the invention, when read in conjunction with the accompanying drawing in which:

FIG. 1 provides a plan view of an angled driver flexible extension shaft, in accordance with features of the present invention;

FIG. 2A provides Cartesian coordinates illustrating one example of torque, bending and range of motion;

FIG. 2B provides Cartesian coordinates illustrating another example of torque, bending and range of motion:

FIG. 2C provides Cartesian coordinates illustrating still another example of torque, bending and range of motion.

FIG. 2D provides Cartesian coordinates illustrating yet another example of torque, bending and range of motion;

FIG. 3 provides a perspective view of an angled driver flexible extension shaft of FIG. 1 used with a portable electric tool, in accordance with features of the present invention;

FIG. 3A provides a transverse cross-sectional view of the angled driver flexible extension shaft taken along line 3A-3A of FIG. 3, in accordance with features of the present invention;

FIG. 3B provides a transverse cross-sectional view of the angled driver flexible extension shaft taken along line 3B-3B of FIG. 3, in accordance with features of the present invention;

FIG. 4 provides a partial perspective view of the flexible extension shaft of FIG. 1 depicted without a removable angled driver, in accordance with features of the present invention;

FIG. 5 provides a longitudinal cross-sectional view of the angled driver flexible extension shaft taken along line 5-5 of FIG. 4, in accordance with features of the present invention;

FIG. 6 provides an enlarged detailed view of the angle driver portion of the angled driver flexible extension shaft, in accordance with features of the present invention;

FIG. 7A provides a partial cut-away view of the angled driver flexible extension shaft in a 160-180 degree orientation, in accordance with features of the present invention;

FIG. 7B provides an alternative torque transfer coupling means, in accordance with features of the angled driver of the present invention;

FIG. 7C is a view of FIG. 7B taken along line 7C; provides another alternative torque transfer coupling means, in accordance with features of the angled driver of the present invention; and

FIG. 8 provides a view of an alternate embodiment of the angled driver flexible extension shaft in a 160-180 degree orientation, in accordance with features of the present invention.

### DETAILED DESCRIPTION OF THE INVENTION

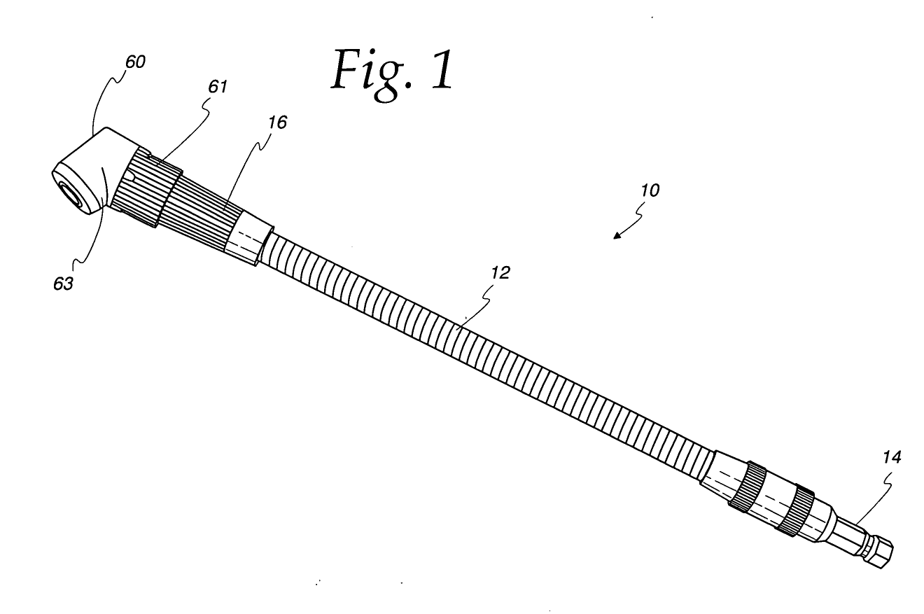

One embodiment of the device is depicted in FIG. 1 and designated generally as numeral 10. Embodiments of the present invention provide a long-lasting device 10 that imparts rotational torque, whether the device is bent or twisted (more than one bend or twist is contemplated) greater than 90 degrees (from 0 degrees up to approximately 360 degrees, but generally greater than approximately 90 degrees up to approximately 180 degrees) throughout 360 degrees range of motion.

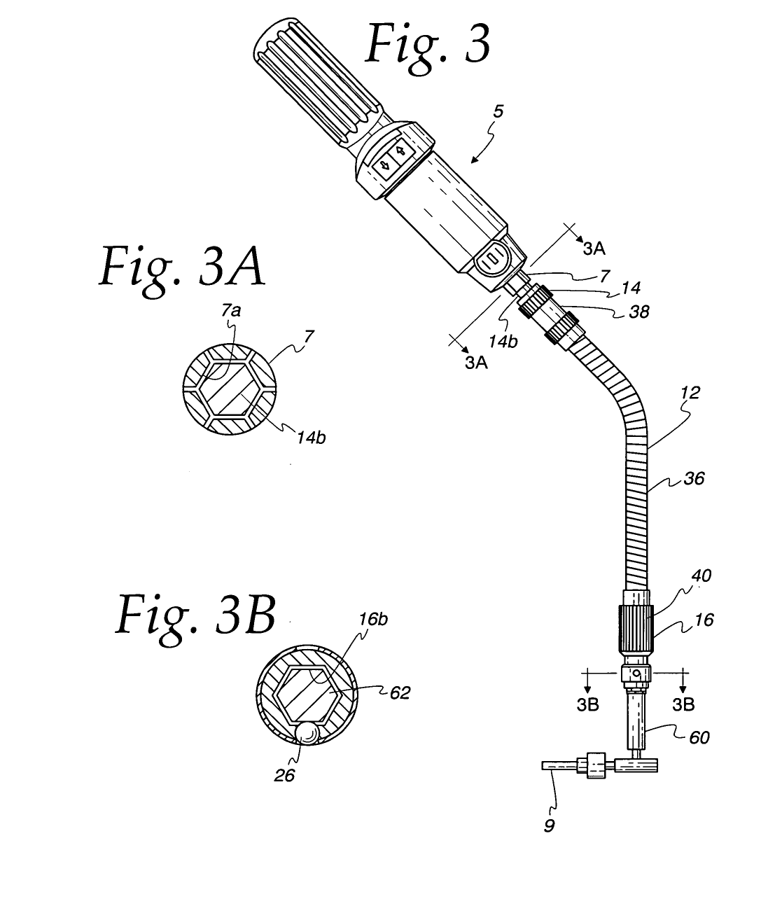

Generally, the device 10 comprises a flexible extension shaft 12, a first end 14, and a second end 16. In one embodiment, the first end 14 is adapted to cooperate with a drive device that provides a means for imposing upon a bit rotational torque in at least one plane and linear force (such as a cordless portable electric screwdriver 5 having a chuck 7 for example, best viewed in FIG. 3). The second end 16 is adapted to receive a bit, a fastener head, another chuck, or the like (alternatively referred to as a work device or tool 9).

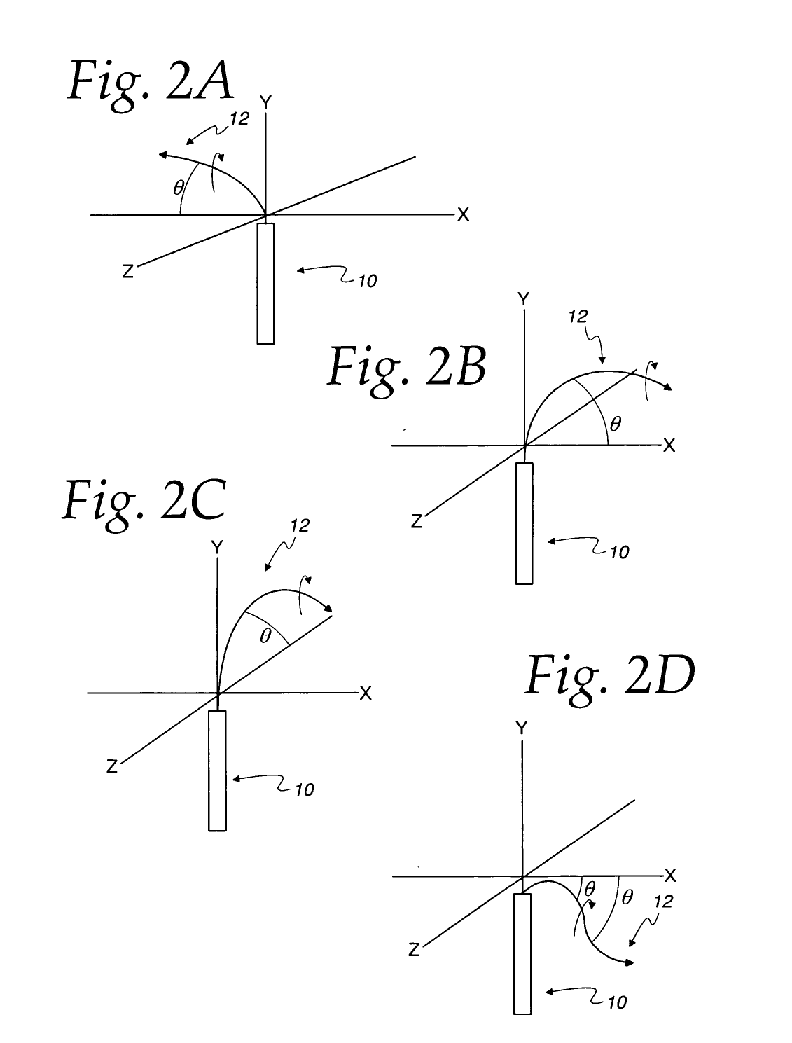

FIGS. 2A, 2B, 2C and 2D depict Cartesian coordinates illustrating examples of torque, bending and range of motion in accordance with at least one embodiment In FIGS. 2A-2D, the device 10 having flexible extension shaft 12 is adapted to form a plurality of different angles θ with the XZ plane. FIGS. 2A-2D illustrates different examples of curving or bending, where the shaft 12 forms different angles θ with respect to the XZ plane (where θ is anywhere from 0 degrees up to approximately 360 degrees) and the arrows indicate spin due to applied rotational torque. It should be appreciated that the terms bend, bent, bends, bending, bending motion, deflectable, deflection, twist, twisting motion, etc. are used interchangeably. It should further be appreciated that a shaft 12 having more than one bend or twist is contemplated (See FIG. 2D illustrating for angles θ and θ′ example). FIGS. 2B-2D further illustrate range of motion or angle of rotation of the shaft 12, where the shaft 12 may form a plurality of different angles a with respect to the XZ plane.

The internal mechanism of one embodiment of the flexible extension shaft 12 is similar to that disclosed in the '929 patent. In the illustrated embodiment, the first end 14 of the flexible extension shaft 12 and the chuck 7 have complementarily shaped non-circular cross-sections (see FIG. 3A). The chuck 7 has an axis (where such axis is substantially coaxial to that of the male fitting “C” which defines the first end 14 as illustrated in FIG. 9). Chuck 7 is adapted to receive the first end 14 of the flexible extension shaft 12 by means of axial insertion of the shaft 12 into the chuck 7 with the non-circular cross-sections in rotationally aligned relationship. The chuck 7 also includes means for holding the first end 14 of the flexible extension shaft 12 for rotary driven motion thereof.

The second end 16 of the flexible extension shaft 12 and angled driver (and similarly the angled driver and tool 9) similarly has complementarily shaped non-circular cross-sections (see FIG. 3B). The drive device 5 operates such that the second end 16 of the flexible extension shaft 12 includes means for holding the tool 9 (such as a bit) for rotary driven motion thereof. With this arrangement, the flexible extension shaft 12 normally is disposed so as to be substantially entirely coaxial with the chuck 7 and is universally deflectable relative to the longitudinal axis α so as to position the second end 16 of the shaft 12 and the tool 9 at an angle relative to the axis α.

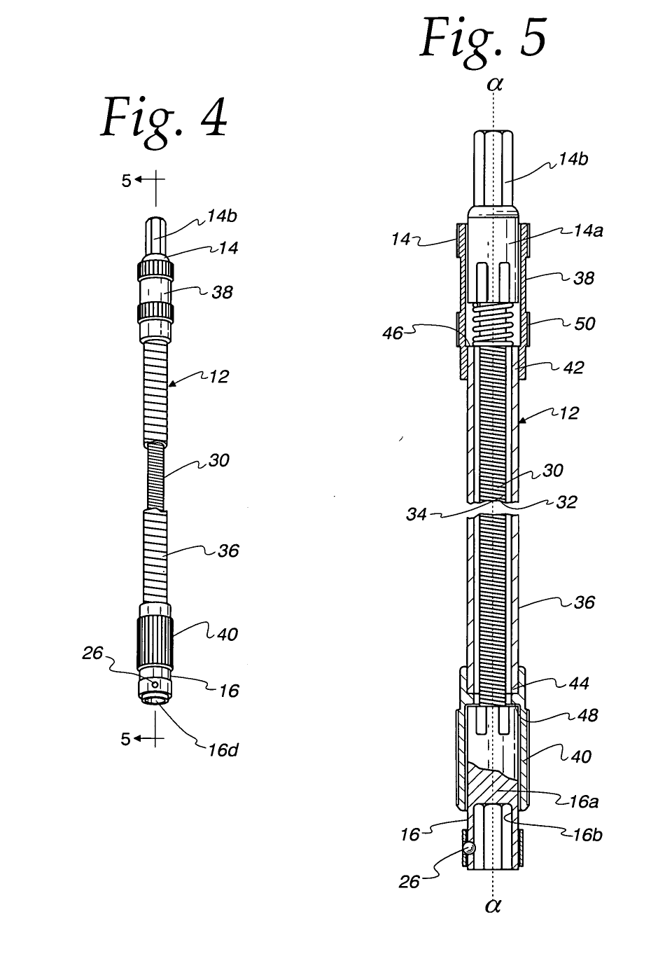

Referring to FIGS. 4 and 5, at least one embodiment of the flexible extension shaft 12 (here depicted without the removable angled driver) includes a plurality of concentric coil springs 30, 32, 34 in tightly wound adjacent relationship extending between and secured to the generally cylindrical body portions 14a and 16a of the first and second ends 14 and 16 of the shaft 12 to accommodate universal deflection of the shaft relative to the axis α. It will also be seen that a flexible sleeve 36 is disposed about the concentric coil springs 30, 32, 34 (which enables the shaft 12 to be held during use). As illustrated, the flexible sleeve 36 has cylindrical fittings 38 and 40 secured thereto at opposite ends 42 and 44 thereof to receive one of the cylindrical body portions 14a and 16a therein. Flexible sleeve 36 and cylindrical fittings 38 and 40 define shoulders 46 and 48 internally of each of the fittings 38 and 40 forming stops for the cylindrical body portions 14a and 16a.

In at least one embodiment, the cylindrical body portions 14a and 16a are spaced apart by a distance greater than the distance between the shoulders 46 and 48 in the cylindrical fittings 38 and 40, permitting axial movement of the cylindrical body portions 14a and 16a and the concentric coil springs 30, 32, 34 relative to the cylindrical fittings 38 and 40 and the flexible sleeve 36. In at least one embodiment, a shaft biasing coil spring 50 is disposed about the concentric coil springs 30, 32, 34 of the flexible extension shaft 12 between the shoulder (such as shoulder 48 for example) in one of the cylindrical fittings (such as cylindrical fitting 40 for example) in the corresponding one of the cylindrical body portions (such as portion 16a for example) to normally bias the other of the cylindrical body portions (such as 14a for example) into engagement with the shoulder (such as 46 for example) in the other of the cylindrical fittings (such as 38 for example).

As will be appreciated by referring to FIG. 3, rotary torque is provided by the drive device (a cordless portable electric drive device 5 for example) through the flexible extension shaft 12. It will also be appreciated that one of the first and second ends of the flexible extension shaft 12, such as the end 14 for example, includes a generally cylindrical body portion 14a terminating in a male hex shank 14b (See FIG. 3A). The other of the first and second ends, such as end 16 for example, includes a generally cylindrical body portion 16a terminating in a female hex shank-receiving opening 16b. It will further be appreciated that the chuck 7 includes a female hex shank-receiving opening 7a, which, together with the male hex shank 14b, defines the first of the previously described complementarily shaped non-circular cross-sections (See FIG. 3A).

In at least one embodiment, the second end 16 is further configured as an angled driver having angle β, such as that depicted in FIGS. 1, 3, 6 and 8-9 and generally designated 60. As depicted in FIG. 3, rotational torque may be applied to a tool 9. It is contemplated that the angled driver 60 is adapted to be either removably connected to the second end 16 of the flexible extension shaft 12 (See FIGS. 4 and 5 for example). Preferably, the angle driver is in rotatable communication with the extension shaft 12.

Alternatively, and as shown in FIG. 1, the angled driver is integrally molded with or fixedly attached to the second end 16.

In the embodiment depicted in FIGS. 6, 7A and 9, the angled driver 60 comprises a proximal first end 62 in male-female cooperation with the second end 16 of the flexible extension shaft 12. In the embodiment depicted in FIG. 6, a male depending shaft 62 is adapted to be removably received in a portion of shaft 12 defining a rotating female coupling 15. The second end 16 may include a detent 26 (See FIGS. 3 and 3B), where the male depending shaft 62 is in male-female cooperation with the female hex shank-receiving opening 16b, defining the second of the previously described complementarily shaped non-circular cross-sections (See FIG. 3B). Further, second end 16 may include a plurality of fingers associated with a rotating female coupling or housing as is well known in the art. It should be appreciated that, in at least one embodiment, the first end 14 of the flexible extension shaft 12 is adapted for insertion into the chuck 7 and the angled driver 60 is adapted for insertion into the second end 16 of the flexible extension shaft 12.

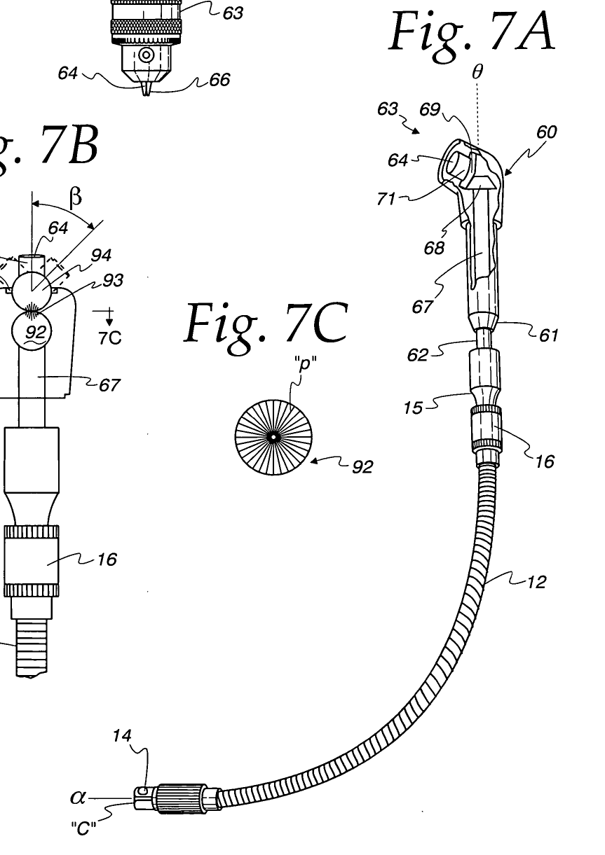

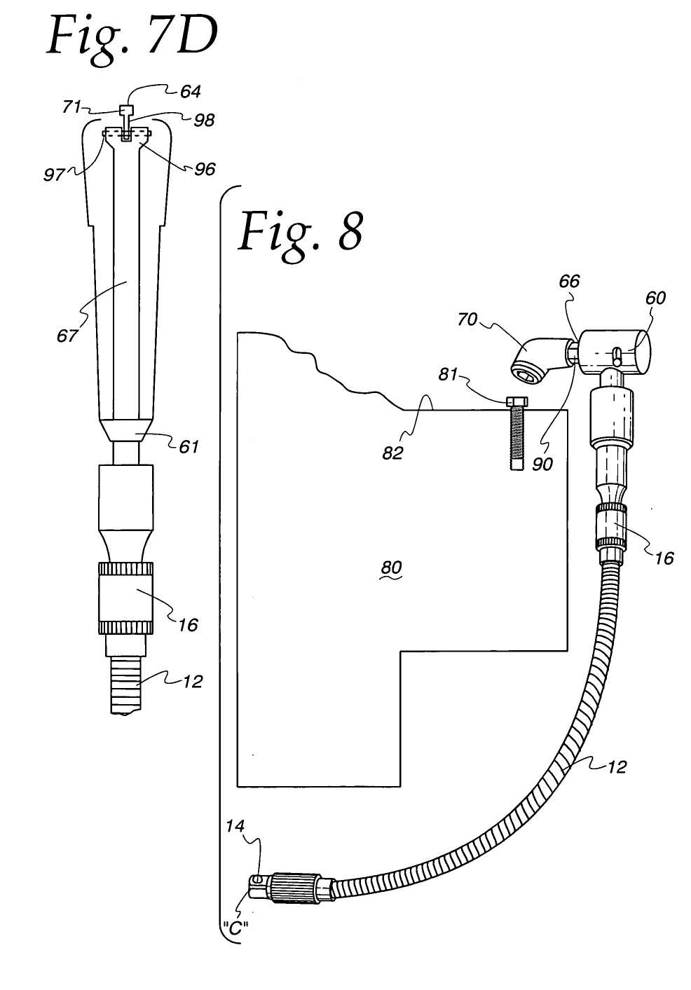

In at least one embodiment, the angled driver 60 comprises a typical helical worm drive mechanism, a beveled gear configuration, or the like. For example, the angled driver comprises a beveled gear configuration depicted as element numbers 67-69 in FIG. 7A. A center shaft 67, extends through a longitudinal axis Φ of the angle driver 60, and when slidably received by the female lifting 15 of the second end of the flexible extension shaft, is coaxial with the rotating cable assembly 30-32 of the flexible extension shaft. The center shaft 67 terminates at a distal end with a first beveled gear 68. A second beveled gear 69 is in mating engagement with the first gear 68 and further integrally molded with an elongated housing 71 defining an aperture 64 adapted to receive a bit, fastener, or other workpiece having a cross section complementary to the aperture. To enhance engagement between the aperture 64 and the workpiece, a magnet or ball-detent mechanism (said mechanism similar to that described in the '929 patent incorporated by reference herein) is integrally molded with the housing 71.

The positioning of an angled driver at the second or distal end 16 of the flexible extension shaft allows torque, derived from the internal cable combination (element numbers 30, 32, and 34) to be transferred to a point 61 on the driver 60 proximal to the second end 16. This allows the rotational torque originally supplied by the operator handle 5 to be applied to a different axis of rotation which is at an angle β different than the first axis of rotation provided by the free end 16. It is contemplated that angle β may be fixed or adjustable. Depending on the internal configuration of the angle driver 60, the angle β can vary from greater than 0 degrees to less than 180 degrees, but generally approximately 60 degrees to approximately 90 degrees relative to second end 16. In at least one embodiment, angled driver 60 may include an adjustable drive mechanism and housing that enables angle β to be adjustable.

Means for conferring such an adjustable angle β includes, but is not limited to, a yoke-and-tang configuration, an intermeshing multi-sphere configuration, and a combination thereof. FIG. 7B depicts the aforementioned intermeshing sphere configuration. A salient feature of this configuration is the juxtaposition of two spheres 92, 94 in close spatial relation to each other. Each of the spheres contains a surface 93 defining teeth, each tooth defining an elongated ridge or crest radiating from a single point “P” on the surface. The depiction of the teeth is found in FIG. 7C. The length of the teeth can vary so as to extend up to 75 percent of the surface of the sphere. When taken in their entirety, the teeth on each sphere radiate outwardly from their point of origin so as to extend substantially 360 degrees about the point.

The two spheres 92, 94 contact each other at their respective teeth-containing regions 93 so as to cause male-female interaction, (i.e. meshing, engagement, nesting, etc) of the crests of teeth of one sphere with the troughs defined by the regions between teeth crests on the other sphere. Contact between the spheres is maintained via a retaining collar 95 attached to a portion of the housing of the angle driver and encircling a periphery of the distal-most sphere 94, whereby said periphery is smaller than the circumference of the sphere. The retaining collar 95 is removably attached to the housing of the distal end 63 of the angled driver via a spring clip or other typical retaining means. The collar is adapted to be received and retained in a portion of an interior surface of said housing that defines an annular grove.

The first sphere is attached to the distal end of the actuating shaft 67. The second sphere 94 is received by the housing of the distal end 63 of the angled driver so as to allow rotation of the second sphere 94 relative to the first sphere 92. This rotation enables the first sphere to confer motion to the second sphere when the shaft 67 rotates such that the distal aperture 64 of the angled driver also rotates. While FIG. 7B shows the spheres arranged such that the axis of rotation of the distal aperture is coplanar to the axis of rotation of the shaft 67, this is not always the case. FIG. 7B depicts alternative positions of the second sphere 94 (see dotted line detail). These alternative positions confer axes of rotation of the distal aperture that are not coplanar to the axis of rotation of the actuating shaft 67.

Another embodiment to confer varying angles for the tool 9 to emanate from the angled driver include a yoke-and-tang configuration, such as that depicted in FIG. 7D. This configuration includes a yoke 96 fixedly attached to the distal end of the driver's rotating shaft 76. A tang 98 nests within, and is in rotatable communication with, the yoke 96 via a rod 97 extending transversely through the yoke and tang.

A distal end of the tang 98 terminates in a housing 71 virtually identical to that which defines the distal opening 64 of the angled driver of the aforementioned embodiments.

In operation, the tang rotates within the yoke along a 180 degree arc, so as to confer up to a 90 angle for β. With the rotation of the drive shaft 67, a fastener, tool bit, or other angled driver inserted into the distal opening 64 is enabled to engage with a workpiece anywhere along a first plane defined by the 180 degree arc. Given that the arc is further rotated 360 degrees in a second plane perpendicular to the first plane, the yoke and tang device, as with the intermeshing spheres configuration discussed supra, enables a user to apply the tool 9 to a workpiece at any point on a half hemisphere so defined by the range of motion of the distal opening.

The tool or bit 9 is thus positioned at a terminus point 63 on the driver 60 (i.e., a point 63 on the driver 60 distal from the second end 16) in rotatable communication with the shaft 12 and at that angle β. The angle β of the angled driver 60, combined with the angle of the chord line (that line defined by the positions of first and second ends 14, 16 of the flexible extension shaft 12) provides the user with a wide range of angles in which to manipulate the tool 9.

Referring to FIGS. 2, 6 and 8-9, means for securing or holding the tool 9 to the angled driver include a male-female coupling whereby the distal end 63 of the angled driver is adapted to slidably receive a proximal end of the bit 9. In at least one embodiment illustrated in FIG. 6, and as mentioned supra, terminus point 63 may comprise a rotating coupling or housing defining an aperture or female hex-shank receiving opening 64 having a plurality of fingers 66 associated therewith as is well known in the art. Additionally, the distal end or terminus point 63 of the angled driver 60 may include a detent (similar to detent 26 in FIG. 3B) associated with the female hex shank-receiving opening 64 adapted to removably receive a male hex shank 9A, said shank defining the proximal end of the tool 9 and integrally molded therewith. The distal opening 64 of the angled driver defines a complementary shaped non-circular cross section in mating cooperation with the tool 9 similar to that illustrated in FIG. 3B. With this arrangement, the first end 14 of the flexible extension shaft 12 is adapted for insertion into the chuck 7 and the tool 9 is adapted for insertion into the one or more angled drivers 60.

As should now be appreciated, the cordless portable electric drive device 5 when utilized with the unique flexible extension shaft 12 is extremely versatile. The fact that it is universally deflectable relative to the axis α accommodates use of the drive device 5 in hard-to-reach or limited access areas since the tool 9 can be disposed at an acute angle relative to the axis α by deflecting or bending the flexible extension shaft 12 such as illustrated in FIGS. 2A-2D, 3, 8 and 10. In this connection, the flexible sleeve 36 permits the user to grip the flexible extension shaft 12 to hold it in a deflected position during use without exposure to the moving parts.

The drive device is used to provide rotational and linear force to at least the first end 14. Providing such torque and force to the first end 14 causes the concentric coil springs 30, 32, 34 to rotate internally in the flexible sleeve 36. The difference in distance between the cylindrical body portions 14a and 16a and the cylindrical fittings 38 and 40 accommodate the arc into which the flexible extension shaft is oftentimes advantageously deflected and held during use of the drive device.

More than one angled driver device is contemplated. A second angled driver 70 may be removably mated with the distal end 63 of the first angled driver 60 via any of the arrangements provided previously, allowing independent rotational positioning between drivers 60, 70. Alternatively the drivers can be mated with each other via hexagonal shaft/aperture configurations to minimize slippage and ensure full transfer of rotational torque. Additionally, the angled drivers 60, 70 may be fixedly mated. Therefore, the two drivers may be angularly offset from each other along the plane of rotation of the internal rotating shaft. It should be understood that, while only two angled drivers 60, 70 are discussed, more than two angled drivers are contemplated.

More specifically, as shown in FIG. 9, drive shaft 90 of a second angular driver 70 is inserted in and driven by the terminus point 63 (i.e., the distal end) of the first angled driver 60. This configuration allows imparting rotational torque at 180 degrees with a very compact configuration that can circumvent regions of a machine 80 in need of repair so as to arrive at a trouble region 82 of the machine, perhaps a loosened fastener 81.

At least one embodiment comprises a method for imparting rotational and linear force to a tool using the device 10 in any configuration or arrangement described previously. In this embodiment, a work angle is determined; such as circumventing regions of the machine 80 in need of repair so as to arrive at a trouble region 82.

One embodiment of the method comprises determining the one or more angles needed to reach the trouble region and bending the flexible extension shaft 12 (greater than 90 degrees for example). A drive device 5 is used to provide rotational and linear force to at least the first end 14, wherein the first end 14 is adapted to provide rotational and linear force to at least the second end 16 along a 360 degree range of motion as described previously. The tool 9 is inserted into the one or more angled drivers 60, and rotation torque is provided.

While the invention has been described with reference to details of the illustrated embodiment, these details are not intended to limit the scope of the invention as defined in the appended claims. For example, the device can incorporate a plurality of angled drivers, perhaps three or more and mirrors at each driver point to aid in the manipulation of extremely intricate machinery. The mirrors are provided to facilitate viewing of the otherwise out-of-sight workpiece surface 82.

The embodiment of the invention in which an exclusive property or privilege is claimed is defined as follows:

1. A device which imparts rotational movement and linear force to a tool, the device comprising:
a) a flexible extension shaft having first and second ends, whereby said first end is adapted to provide rotational movement in a first plane of rotation and liner force to at least said second end; and
b) at least one angled driver coupled to said second end, whereby rotational and liner force is provided to the tool along a 360 degree range of motion.

2. The device as recited in claim 1 wherein said flexible extension shaft is adapted to bend from 0 degrees to approximately 180 degrees from its longitudinal axis.

3. The device as recited in claim 1 wherein said angled driver confers rotational movement to a bit in a second plane of rotation different than the first plane and the second plane is positioned at an angle between approximately 60 degrees and 120 degrees relative to the first plane.

4. The device as recited in claim 3 wherein said second plane of rotation is conferred simultaneously with said first plane of rotation.

5. The device as recited in claim 1 wherein said angled driver is integrally molded with said second end.

6. The device as recited in claim 1 wherein said angled driver is removably coupled to said second end.

7. The device as recited in claim 1 further comprising at least one other angled driver coupled to and driven by said at least one angled driver.

8. The device as recited in claim 1 wherein said first end is adapted to be received in a rotating chuck providing at least said rotational movement.

9. A device that imparts rotational and linear force to a tool along approximately 360 degrees range of motion, the device comprising:
a) a flexible extension shaft having a longitudinal axis, a first end and a second end, whereby said first end is adapted to be received by a rotating chuck; and
b) an angled driver attached to said second end.

10. The device as recited in claim 9 wherein said flexible extension shaft can bend from 0 degrees to approximately 180 degrees from the longitudinal axis.

11. The device as recited in claim 9 wherein said angled driver is formed having a predetermined angle between approximately 60 degrees and 120 degrees.

12. The device as recited in claim 9 wherein said angled driver is removably coupled to said second end.

13. The device as recited in claim 9 wherein said angled driver is integrally formed with the second end.

14. The device as recited in claim 13 wherein said angle may be varied on said angled driver.

15. The device as recited in claim 9 further comprising an additional angled driver coupled to and driven by said angled driver attached at said second end.

16. A method for imparting rotational and linear force to a tool, the method comprising:
a) bending a flexible extension shaft having first and second ends, said second end having at least one angled driver; and
b) providing rotational and linear force to at least said first end, wherein said first end is adapted to provide at least rotational force to at least said second end along a 360 degree range of motion.

17. The method as recited in claim 16 comprising determining a work angle prior to bending said flexible extension shaft.

18. The method as recited in claim 16 comprising bending said flexible extension shaft greater than 90 degrees.

19. The method as recited in claim 16 comprising inserting the tool into said at least one angled driver.

20. The method as recited in claim 16 comprising inserting at least one other angled driver into said at least one angled driver.
